(19) United States
(12) Patent Application Publication
(10) Pub. No.: US 2019/0327200 A1
(43) Pub. Date: Oct. 24, 2019

(54) CUSTOMIZED CONTROLS FOR HANDLING COMMUNICATION CONTENT

(71) Applicant: Microsoft Technology Licensing, LLC, Redmond, WA (US)

(72) Inventors: Jason C. Buckingham, Kirkland, WA (US); Brandon James Lee Haist, Bellevue, WA (US)

(21) Appl. No.: 15/958,553

(22) Filed: Apr. 20, 2018

(51) Int. Cl. H04L 12/58; G06F 3/0484

(52) U.S. Cl. CPC H04L 51/22; G06F 3/0484; H04L 51/12; H04L 51/06

(57) ABSTRACT

Rules with user adaptable controls are created that are not automatically applied to a given email. Instead, satisfaction of the rule triggers a suggestion to the person viewing the mail to take a certain mailbox management action such as, for example, to forward the email to a particular person, tag with a particular category, flag for follow-up at a certain point in time, etc. The rule filters the email as always but the user is given control as to what to do when the rule is satisfied. The notification that is triggered by the rule can be preselected to provide available options to the user with a simple click or can simply provide comments that are cleared by selecting “OK.” Such rules with user adaptable controls may execute multiple mailbox management actions in one step, and also may be used to implement company email policies to help guide employees to follow the correct corporate email protocols.

### BACKGROUND

In existing email systems such as WINDOWS® OUTLOOK® available from Microsoft Corporation, users may establish rules and alerts for managing their incoming and outgoing messages. For example, in OUTLOOK® if one selects “file,” one sees the screen shown in FIG. 1A. Then, if one selects “Manage Rules & Alerts,” one sees the screen shown in FIG. 1B that permits the user to establish a rule and a rule description. If one selects “New Rule,” the Rules Wizard shown in FIG. 1C is invoked to enable the user to select a predefined template and to edit the rule description as indicated. If, for example, the user elects to move messages with specific words in the subject to a folder, the screen shown in FIG. 1D is provided to enable the user to select the appropriate condition from a set of predetermined conditions and to edit the rule description as indicated. For example, if the user selects the condition of “specific words in the subject,” the user is provided the screen shown in FIG. 1E to specify the words or phrases to search for in the subject email. If, for example, the user elects to scan emails for the word “blockchain,” the word “blockchain” is added to the search list as shown in FIG. 1F. Upon selecting “OK,” the user is next presented with the option of selecting the predefined mailbox management action to be conducted when the word(s) in the search list are found in scanned emails. For example, as shown in FIG. 1G, the user may elect to move any emails with the word “blockchain” to a specified folder. As shown in FIG. 1H, the user is presented with a screen to select the appropriate folder in which to place any emails with the word “blockchain.” Upon selection of a folder (e.g., Junk E-mail), the user is provided with the screen of FIG. 1I for deciding what to do with the selected email. In this case, the email is to be moved to the Junk E-mail folder. The user is then provided with the option of selecting one or more predetermined exceptions to the general rule (in this case, of moving emails with the word “blockchain” to the Junk E-mail folder) as shown in FIG. 1J. Finally, the user finishes the rule setup by naming the rule and electing whether to run the new rule on existing messages, future messages, and whether to create the rule on all accounts as shown in FIG. 1K. Of course, any combination of templates may be selected as desired by the user. For more details about the operation of the Rules Wizard, see U.S. Pat. No. 5,917,489 to Scott Thurlow entitled “System and Method for Creating, Editing, and Distributing Rules for Processing Electronic Messages.”

Once a rule is so established, the rule is automatically applied as a filter to all emails into and/or out of the user's email account as specified during creation of the rule. This automatic application of such black/white rules may sometimes lead to unintended results. For example, in the case of the rule created above, all emails with the word “blockchain” would be sent to the Junk E-mail folder. This could be quite problematic if one were to be assigned to a new project relating to the blockchain and the exceptions to the rule were not applicable. On the other hand, if the rule were removed, then the benefit of using rules to manage the user's email inbox/outbox would be lost. Sometimes a user simply wants reminders based on rules and does not want the rules to automatically execute. A different approach is desired that enables the user to implement rules in an unobtrusive manner without losing desirable messages.

### SUMMARY

Various details for the embodiments of the inventive subject matter are provided in the accompanying drawings and in the detailed description text below. It will be understood that the following section provides summarized examples of some of these embodiments.

The embodiments discussed herein relate to the creation of rules of the type discussed above except that the rules are not automatically applied to a given email. Instead, satisfaction of the rule triggers a suggestion to the person viewing the mail to take a certain mailbox management action such as, for example, to forward the email to a particular person, tag with a particular category, flag for follow-up at a certain point in time, etc. Thus, the rule filters the email as always but the user is given control as to what to do when the rule is satisfied. A notification that is triggered by the rule can be preselected to provide available options to the user with a simple click or can simply provide comments that are cleared by selecting “OK.” Also, such rules with user adaptable controls would be especially useful to implement company email policies to help guide employees to follow the correct corporate email protocols.

In a sample embodiment, the disclosure relates to a method of allowing a user to configure a rule/filter that does not automatically execute on receipt of the message, but instead places one or more executable buttons in a notification in the form of, for example, an alert that will execute the rule if the user clicks the button. This allows the user to create rules that are likely to apply to certain messages, but may not always apply. For example, a user may want to frequently flag for follow-up messages from a particular user, but not always. The user could create a rule with user adaptable controls for this condition. When viewing the message, a button (or MailTip-type suggestion) would issue an alert in the message reader notifying the user that the message meets a user specified rule criterion and ask the user if the user wishes to apply the criterion with a single click. Such rules with user adaptable controls may execute multiple mailbox management actions in one step, but the alerts may only display on the particular messages to which they apply.

In particular embodiments, users are provided with tools to create rules that do not execute automatically but instead create an executable reminder to the user when viewing the message. For example, some embodiments include methods, systems, and computer readable media for filtering electronic messages comprising receiving from a user at least one criterion for filtering electronic messages, at least one mailbox management action to be executed upon satisfaction of the at least one criterion, and a notification to be presented prior to execution of the at least one mailbox management action upon satisfaction of the at least one criterion. Sample mailbox management actions include forwarding the electronic message to a particular person, tagging the electronic message with a particular category, storing the electronic message in a particular folder, and flagging the electronic message for follow-up at a certain point in time. Upon receipt of an electronic message, the electronic message is evaluated to determine that the electronic message satisfies the at least one criterion and, in response to determining that the electronic message satisfies the at least one criterion, a notification corresponding to a satisfied criterion is issued, the notification including at least one graphical user interface (GUI) input element prompting a user to provide an input via the at least one GUI input element to select a mailbox management action from at least one mailbox management action presented in the notification. Upon receiving a user input via the at least one GUI input element selecting a mailbox management action from the at least one mailbox management action presented in the notification, the selected mailbox management action is executed on the electronic message. In sample embodiments, the at least one mailbox management action presented in the notification for selection corresponds to the at least one mailbox management action, specified by the user during execution of the setup instructions, that is to be executed upon satisfaction of the at least one criterion. In some embodiments, the notification includes text providing context for the mailbox management action to be taken upon satisfaction of the at least one criterion. In other embodiments, the at least one mailbox management action comprises at least two mailbox management action possibilities for user selection upon satisfaction of the at least one criterion and the notification prompts the user to select one of the at least two mailbox management action possibilities for execution.

Further embodiments may also enable the user to select whether a received electronic message is to be evaluated against the at least one criterion upon receipt or when the electronic message is opened by the user for viewing. Also, in further embodiments, the notification may be issued by issuing a popup window alert or another graphical control element such as an InfoBar alert containing alert text setting forth the at least one mailbox management action and buttons or icons to allow the user to react to the event described in the InfoBar. The popup window alert or the InfoBar alert may be issued each time the electronic message is viewed by the user or only a first time the message is viewed by the user and then dismissed.

The respective algorithms used to implement the functions of the techniques described herein may include a sequence of some or all of the operations described above, or other aspects depicted in the accompanying drawings and detailed description below.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIGS. 1A-1K illustrate graphical user interfaces used to setup a rule in a prior art email system.

FIG. 1A illustrates the screen presented when one selects “file” in a prior art email system.

FIG. 1B illustrates the screen presented when one selects “Manage Rules & Alerts” that permits the user to establish a rule and a rule description in a prior art email system.

FIG. 1C illustrates the Rules Wizard invoked to enable the user to select a predefined template and to edit the rule description when one selects “New Rule” in a prior art email system.

FIG. 1D illustrates the screen presented when the user elects to move messages with specific words in the subject to a folder to enable the user to select the appropriate condition from a set of predetermined conditions and to edit the rule description in a prior art email system.

FIG. 1E illustrates the screen presented when the user selects the condition of “specific words in the subject” to specify the words or phrases to search for in the subject email in a prior art email system.

FIG. 1F illustrates the screen presented when the user elects to scan emails for the word “blockchain” in a prior art email system.

FIG. 1G illustrates the screen presented when the user is presented with the option of selecting the predefined mailbox management action to be conducted when the word(s) in the search list are found in scanned emails in a prior art email system.

FIG. 1H illustrates the screen presented to enable the user to select the appropriate folder in which to place any emails with the word “blockchain” in a prior art email system.

FIG. 1I illustrates the screen presented to the user for deciding what to do with the selected email once a destination folder has been selected in a prior art email system.

FIG. 1J illustrates the screen presented to provide the user with the option of selecting one or more predetermined exceptions to the general rule in a prior art email system.

FIG. 1K illustrates the screen presented to the user to name the rule and to elect whether to run the new rule on existing messages, future messages, and whether to create the rule on all accounts in a prior art email system.

FIG. 2 illustrates a flow diagram of an implementation of a rule with user adaptable controls in sample embodiments.

FIG. 3A illustrates a sample screen presented to the user to enable the user to select an automatic rule or a rule with user adaptable controls in sample embodiments.

FIG. 3B illustrates a sample screen for enabling the user to select the notification text to be presented when the conditions for a rule with user adaptable controls are satisfied in sample embodiments.

FIG. 3C illustrates a sample screen for enabling the user to select when to run the rule with user adaptable controls, what type of notification to provide, and how many times the notification is presented in sample embodiments.

FIG. 4 illustrates a sample logic flow of a module used to implement the systems and methods described herein.

FIG. 5 illustrates a block diagram of a machine adapted to read instructions from a machine-readable medium (e.g., a machine-readable storage medium) and to perform any one or more of the methodologies discussed herein.

### DETAILED DESCRIPTION

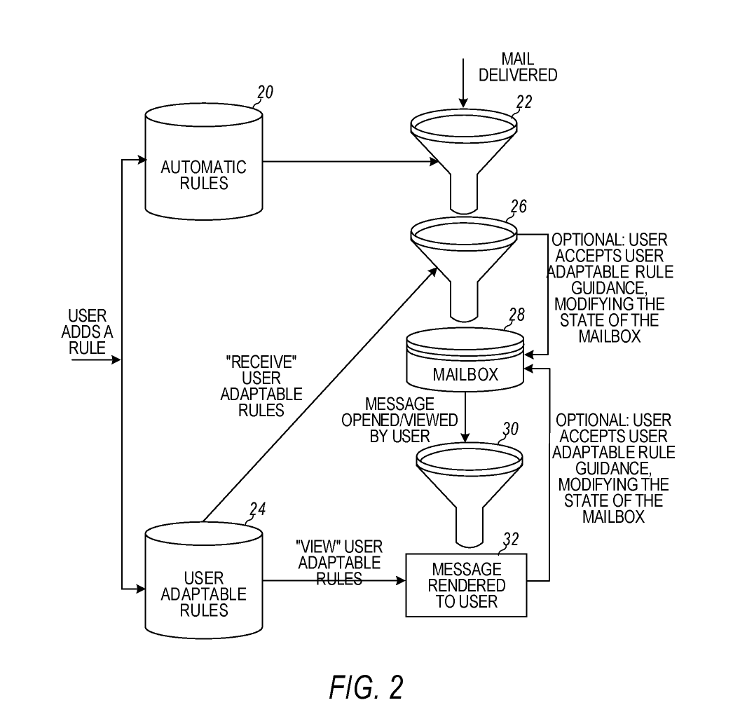

The following description with respect to FIGS. 2-5 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those claims.

The system and methods described herein provide users with more control over the flow of messages into or out of their email mailbox, thus reducing the mis-delivery of automatically filtered messages. Embodiments of the system and method described herein improve the computer functionality by improving the user interface to process rules to enable the semi-automatic delivery of email messages without the mis-delivery possibilities in the prior art. Also, embodiments of the system and method described herein provide better control over implementation of company email protocols by creating rules with user adaptable controls to implement corporate email policy. For example, a particular user or an IT administrator for an entire office may require that all messages from certain servers be flagged as “inappropriate.” The user or the IT administrator may further determine that the flagged message not be automatically delivered to “Junk E-mail,” which may be desired if, for example, the recipient is doing work for the company whose messages are being flagged. In this example, the users could be presented with MailTips (an informative message displayed to a user while the user is composing a message, such as an alert that the user is about to click “reply all” to a large distribution list, send sensitive information to someone outside the organization or send a message to someone who is out of the office), dialog boxes, etc., setting forth the company policy regarding such emails. Thus, the sample embodiments provide the best features of automation to address problems unique to a computer implementation while also enabling user selectivity and reducing email delivery errors in a way that improves the computer implementation.

An automatic rule as used herein relates to a rule and associated alert for managing incoming and outgoing messages in an email system where the rule is automatically applied as a filter to all emails into and/or out of the user's email account as specified during creation of the rule. Typically, the automatic rule is based on behavior of the user and the context of the behavior.

On the other hand, a rule with user adaptable controls in accordance with the embodiments described herein relates to a rule that does not automatically execute on receipt of an email message, but instead places one or more executable buttons in a notification in the form of, for example, an alert that will execute the rule at the user's election. The with user adaptable controls rule is created for application to certain messages but is not automatically applied without user approval. As with automatic rules, the rule with user adaptable controls is based on behavior of the user and the context of the behavior.

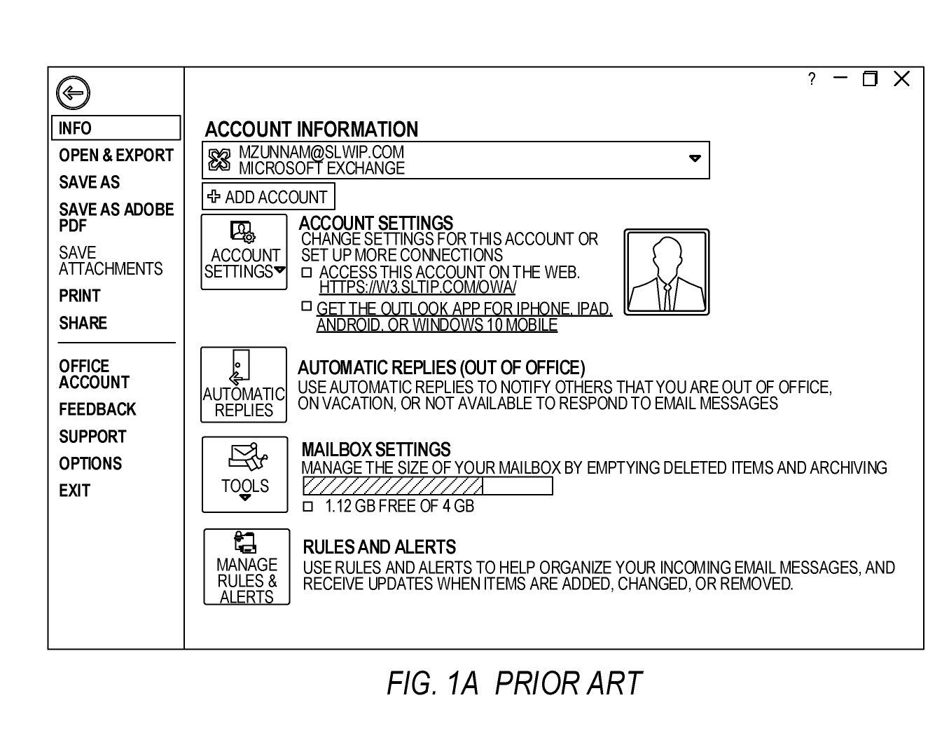

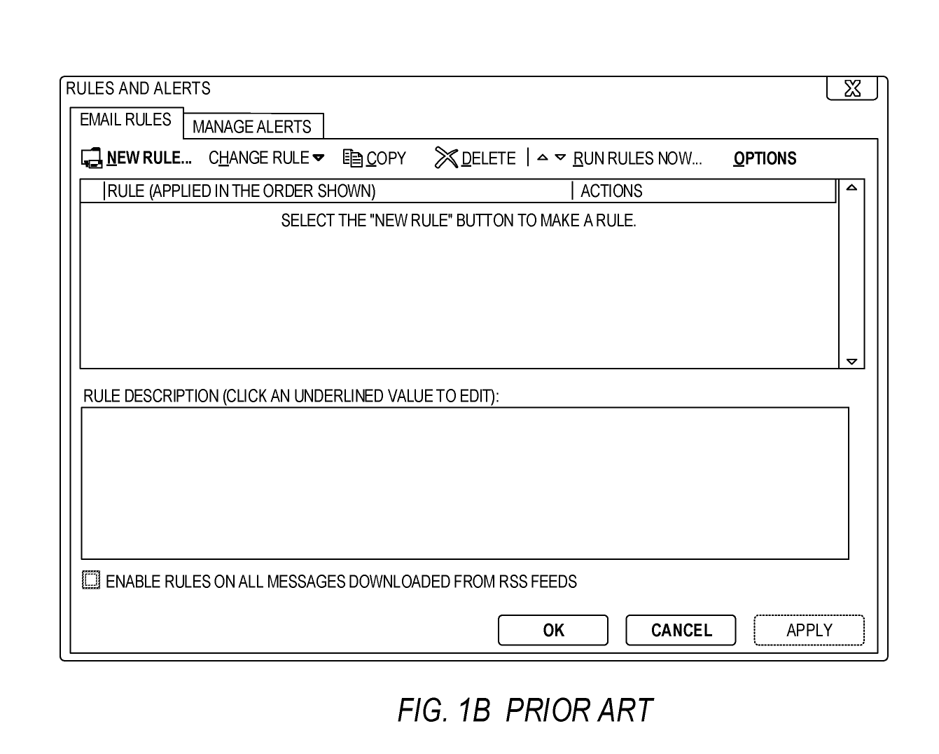

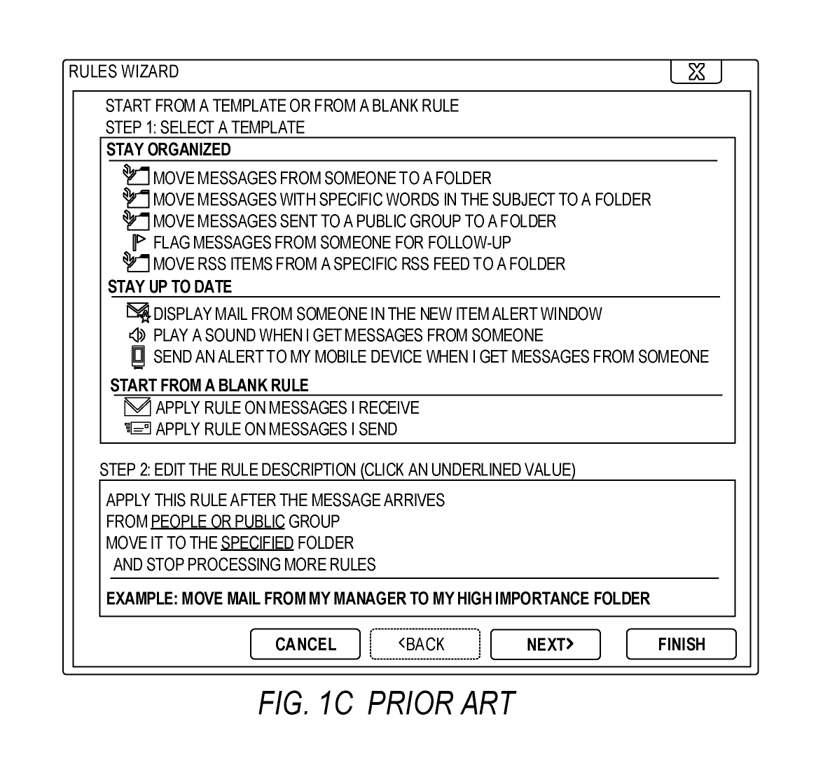

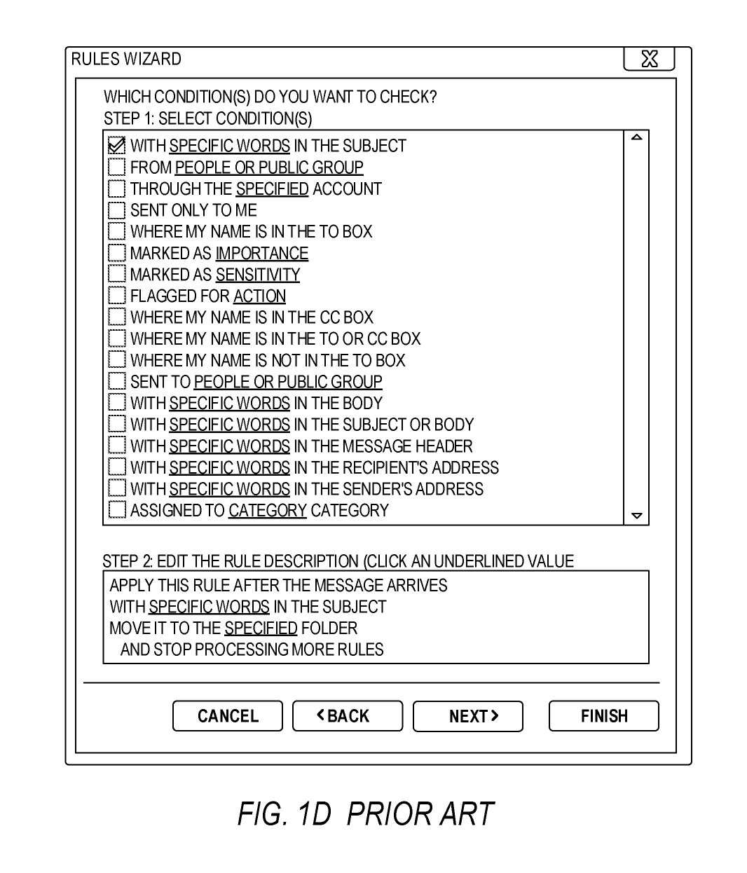

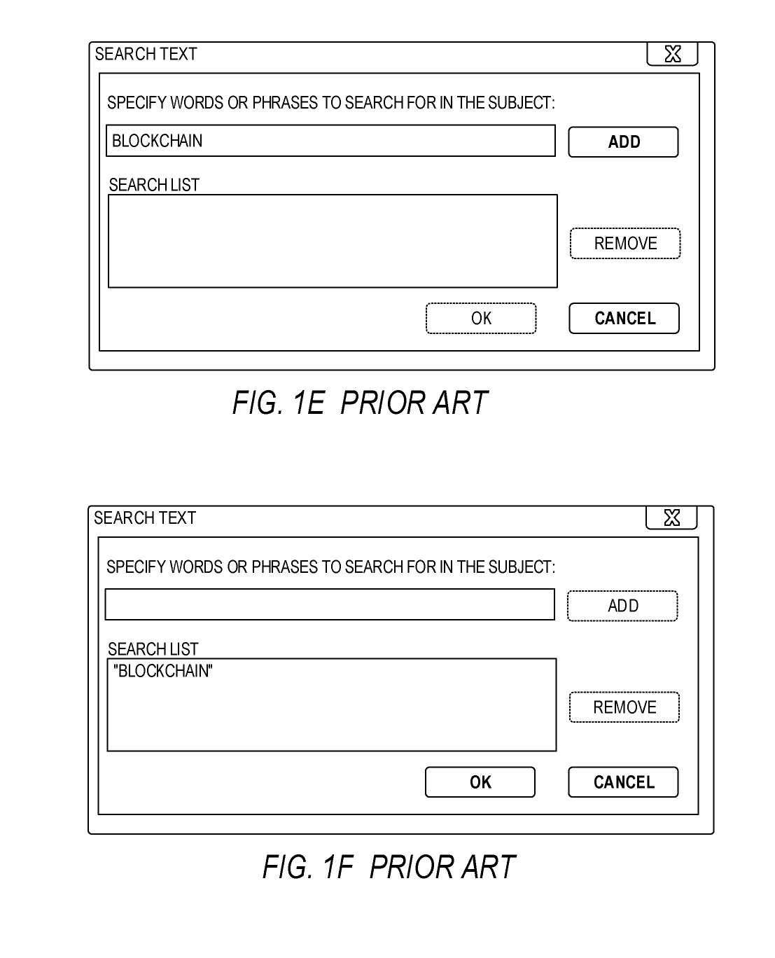

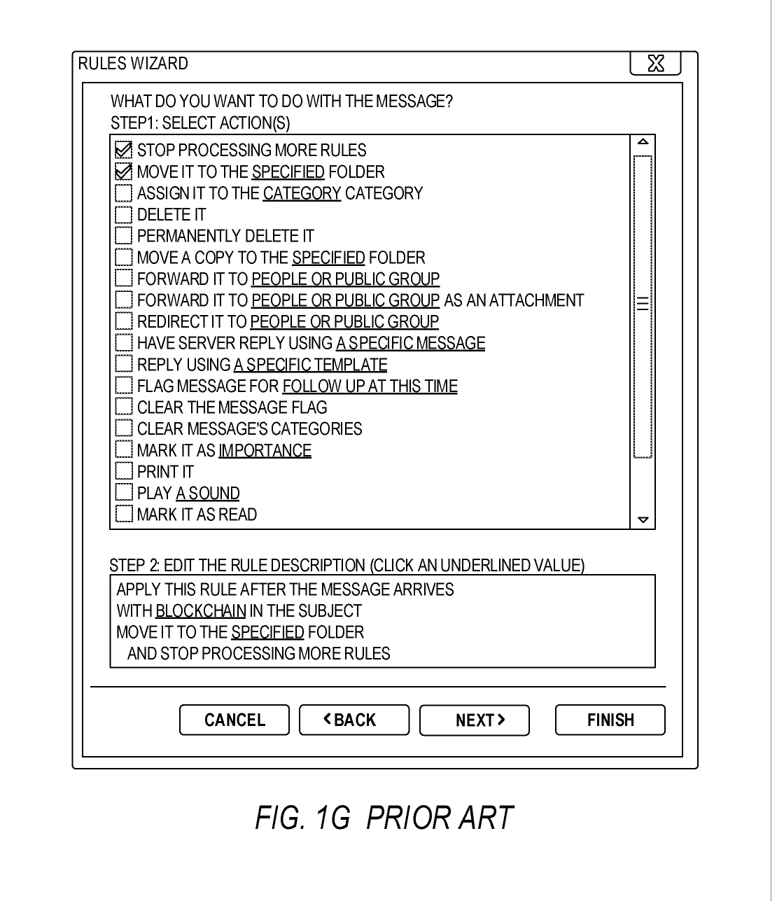

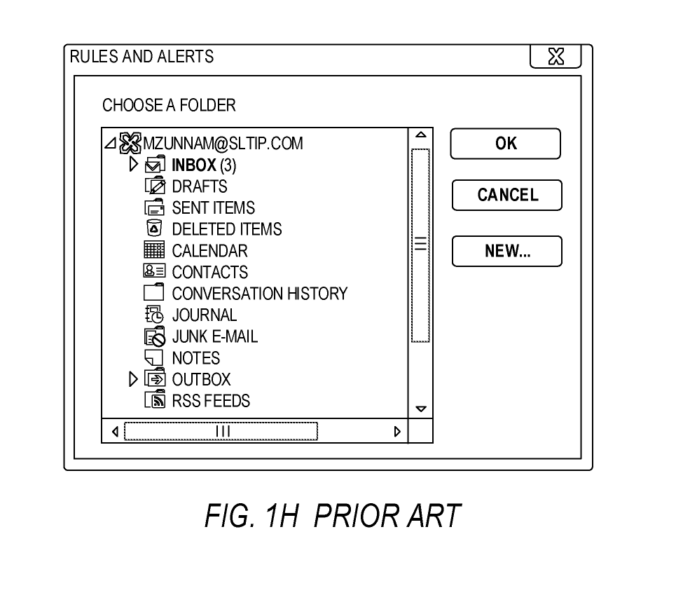

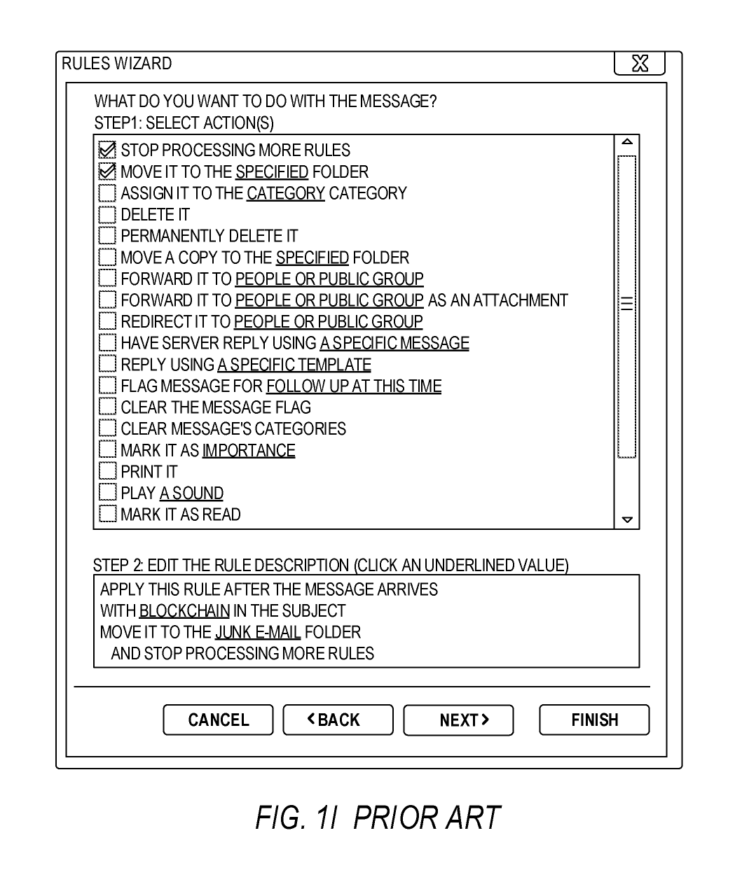

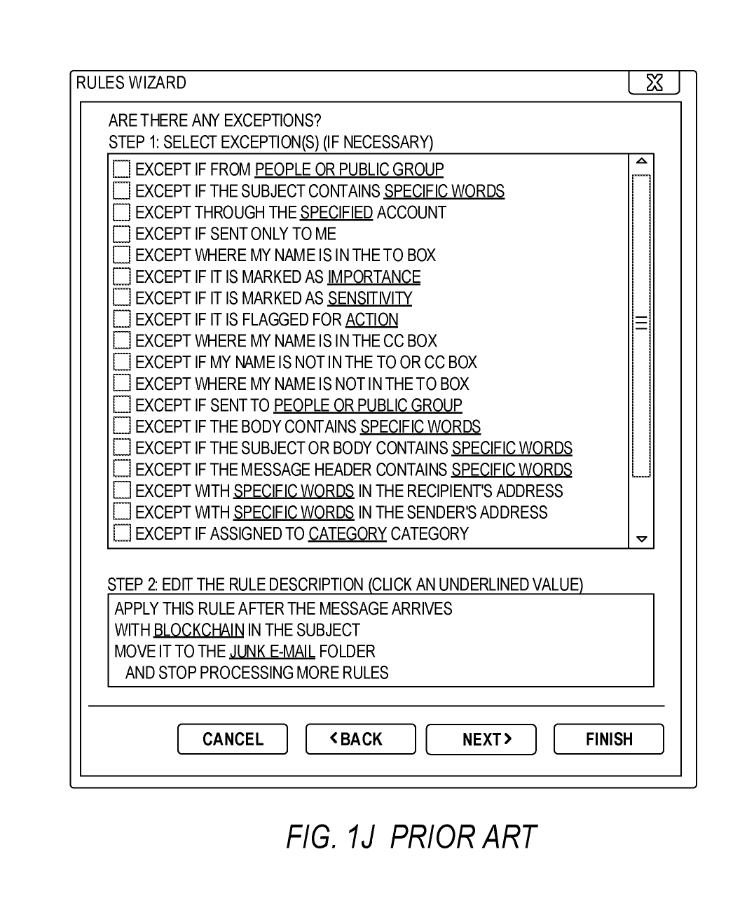

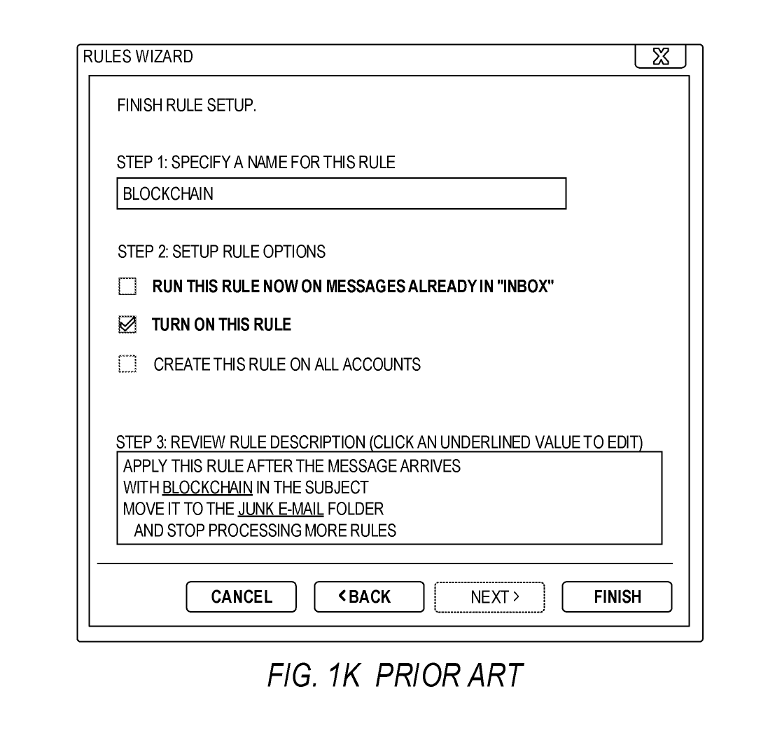

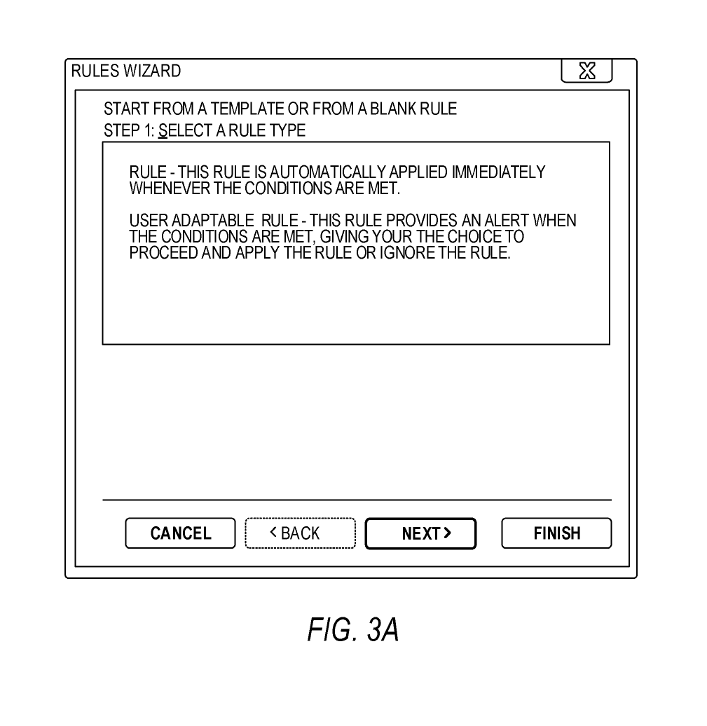

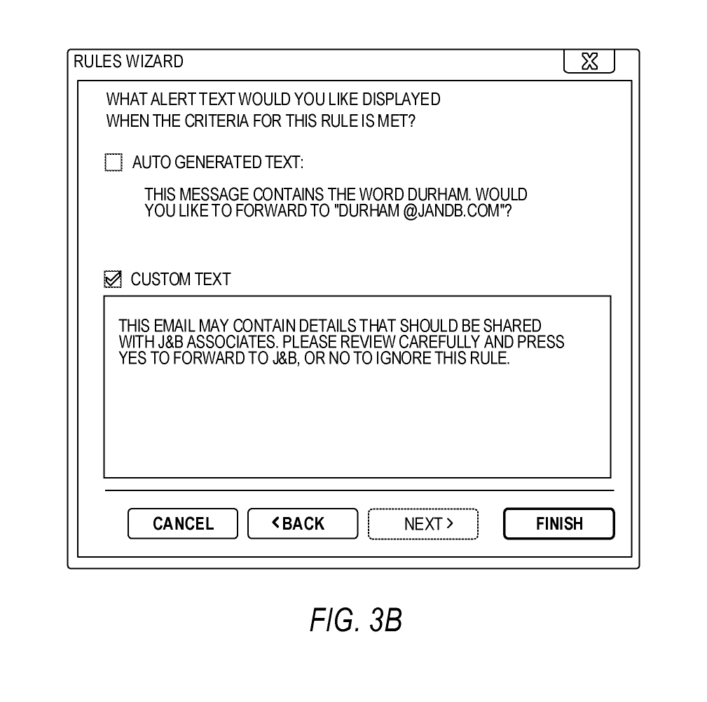

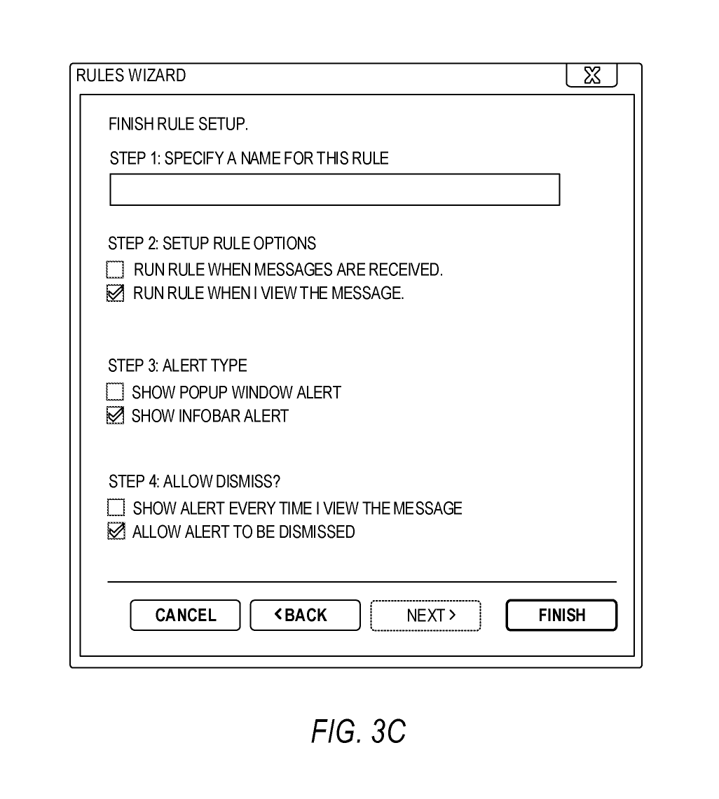

FIG. 2 illustrates a flow diagram of an implementation of rules with user adaptable controls in sample embodiments. As illustrated, the user adds a rule specifying the mailbox management actions to be taken upon satisfaction of the at least one rule criterion. As used herein, the “actions” to be taken upon satisfaction of the at least one rule criterion do not relate to activities before the email is sent such as parsing the text of an email to determine to whom to send an email but instead relate to actions for managing the user's mailbox by specifying what to do with the message upon receipt, what to do with the message after the message has been viewed by the user, or what to do with the message after the message has been sent (e.g., forward the email to a particular person, tag with a particular category, store in a particular folder, flag for follow-up at a certain point in time, etc.). The rule is added using a flow similar to that described above with respect to FIG. 1, except modified to implement rules with user adaptable controls as described herein. In a sample embodiment, once the user enters the Rules Wizard, the user is presented with a screen like that shown in FIG. 3A that enables the user to select an automatic rule or a rule with user adaptable controls in sample embodiments. As noted, the automatic rule is automatically applied immediately whenever the specified conditions are met, while a rule with user adaptable controls provides a notification when the conditions are met, giving the user the choice to apply or to ignore the rule using automatically generated alert text or custom alert text selected by the user in the Rules Wizard as illustrated in FIG. 3B. Generally, the notification provides recommendations to the user based on the at least one rule criterion. As the alerts provided in the notifications may be created by the user, the alerts provide the user the opportunity to specify the conditions to be met in the alert text and the user's options for responding. The response could be a simple “yes,” “no,” “OK,” or a selection from a number of options presented in the form of an informative message displayed to users while they compose a message (e.g., a MailTip on a Microsoft Exchange Server), for example. In any case, the user is given context as well as the option as to whether or not to apply the rule. If the added rule is an automatic rule 20, the automatic rule is applied at 22 to automatically filter the delivered mail based on the conditions specified in the automatic rule. On the other hand, if the added rule is a rule with user adaptable controls 24, the rule with user adaptable controls is applied at 26.

As illustrated in FIG. 2, the rule with user adaptable controls may be applied to a message when the message is delivered. In this case, the rule with user adaptable controls is applied at 26 to filter the delivered mail based on the conditions specified in the rule with user adaptable controls before or after the mail is delivered to the mailbox 28 but before being viewed by the user. In this case, the user is presented with the rule guidance provided by the rule with user adaptable controls and the mailbox 28 is updated based on the user's selection of the available options for applying or ignoring the rule with user adaptable controls. On the other hand, the rule with user adaptable controls may be applied not when the mail is received but instead applied when the mail is viewed. In this case, the rule with user adaptable controls is applied at 30 to the mail retrieved from the mailbox 28 when the message is delivered to the user at 32 for viewing the previously delivered mail. As in the “receive” case, the user is presented with the rule guidance provided by the rule with user adaptable controls and the mailbox 28 is updated based on the user's selection of the available options for applying or ignoring the rule with user adaptable controls. FIG. 3C illustrates a sample screen for enabling the user to select when to run the rule with user adaptable controls—either when the message is received or when the message is viewed and what type of alert to provide—in sample embodiments as either a popup window alert or an InfoBar alert. As used herein, an InfoBar is a graphical control element that appears as a temporary extension of an existing toolbar and may contain buttons or icons to allow the user to react to the event described in the InfoBar. In contrast to a dialog box, the InfoBar does not interrupt the user's activities in one or more of the windows in the graphical user interface (GUI). The user may also elect how many times the alert is presented—either evert time the message is viewed or the alert is dismissed after the first viewing.

FIGS. 3A-3C show sample screens indicating how the implementation of rules in an email system such as OUTLOOK® is modified during setup to include rules with user adaptable controls as described herein. For example, FIG. 3A illustrates what the first screen in the Rules Wizard would show in a sample embodiment. In a sample embodiment, the screen in FIG. 3A would be presented between the screen shown in FIG. 1B and FIG. 1C noted above. FIG. 3B illustrates that the text alert could be automatically generated based on the rule settings, or the text alert could be custom set by the user. In a sample embodiment, the screen in FIG. 3B would be presented between the screen shown in FIG. 1J and FIG. 1K, or at any other time prior to finishing the Rules Wizard. FIG. 3C could be used in place of FIG. 1K as the last screen of the Rules Wizard. Thus, it will be appreciated by those skilled in the art that as the user runs the Rules Wizard as modified to include rules with user adaptable controls as described herein, all the options/settings that exist in conventional versions of the Rules Wizard are otherwise the same with the exception that the existing steps in the Rules Wizard would appear in the workflow between FIG. 3A and FIG. 3B. Of course, some additional options for rule types could be created for rules with user adaptable controls, but the workflow would be the same.

To illustrate operation of rules with user adaptable controls, an example scenario is provided. An agency, Jasmine Marketing, is working on a project with a client. The project is called “Durham” and the client is J&B Associates. The agency exchanges emails internally about various projects and their statuses. Some emails contain information that should be reviewed by J&B Associates, while other emails contain only internal discussion that should not be shared with J&B Associates.

An employee at Jasmine Marketing, either an individual worker or the Jasmine Marketing IT Administrator, creates a rule with user adaptable controls in an email system implementing the rule with user adaptable controls system described herein. The rule with user adaptable controls is configured to show an InfoBar at the top of any email that contains the word “Durham.”

Then, when the user views emails containing the word “Durham,” the user sees a notification such as that shown in FIG. 3B at the top of the email that allows them to automatically execute the pre-configured rule with user adaptable controls, or allows them to ignore the rule with user adaptable controls. In this example, the user may want to execute the rule with user adaptable controls if the email should be forwarded, but ignore the rule if the message contains internal-only discussion about the Durham project. Buttons may be provided in an alert to enable the user to easily select to “forward” or “ignore.” On the other hand, the alert could simply inform the user that the message should be evaluated to determine whether or not to forward without a selection to “forward” or “ignore.” In this case, the user could simply select “OK” to dismiss the alert.

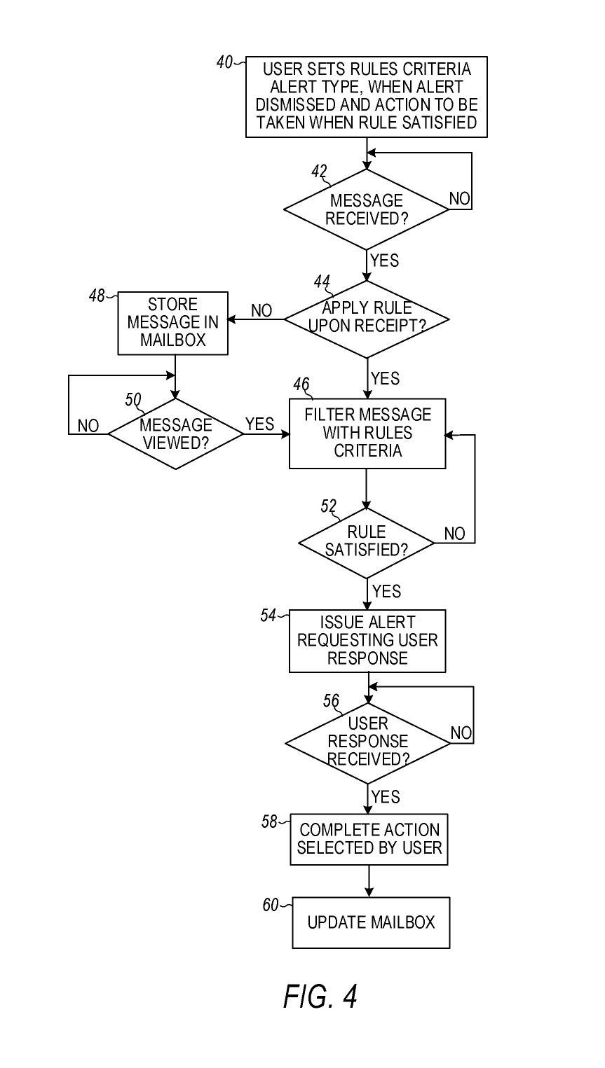

FIG. 4 illustrates a sample logic flow of a module used to implement the systems and methods described herein. As illustrated in FIG. 4, the user is initially provided interfaces at 40 such as those shown in FIG. 1 and FIG. 3 to elicit user input for setting the at least one criterion for each rule, alert type for the notification, when the alert is to be dismissed, action to be taken when the rule is satisfied, and the like. As noted above, the actions to be taken upon satisfaction of the at least one rule criterion relate to managing the mailbox including what to do with the message upon receipt, what to do with the message after the message has been viewed by the user, what to do with the message after the message has been sent (e.g., forward the email to a particular person, tag with a particular category, store in a particular folder, flag for follow-up at a certain point in time, etc.), and the like. Once the rules have been set, the mail server awaits a message at 42 until a message is received. If the user elected to apply the rule upon receipt of a message at 44, the message is filtered with the at least one user-specified rules criterion at 46. On the other hand, if the user elected to apply the rule upon viewing of the message, the message is first stored in the mailbox at 48. When it is determined at 50 that the user has elected to view the message, the message is filtered with the at least one user-specified rules criterion at 46. Messages are filtered by applying the at least one criterion of each rule. Upon satisfaction of one of the established rules at 52, the corresponding alert for that rule is issued at 54 requesting the appropriate user response. If a particular rule is not satisfied, the message is filtered again at 46 with another rule, if more than one rule has been created. As noted above, the alert provides contextual information as appropriate and requests a user response such as “yes,” “no,” “OK,” or a selection from a number of options presented in the form of a MailTip, for example. Generally, the user is given the option as to whether or not to apply the rule. The mailbox management action corresponding to the rule is not implemented until a user response is received at 56, at which time the mailbox management action selected by the user is completed at 58. The mailbox is then updated at 60.

Those skilled in the art will appreciate that the methodology described with respect to FIG. 4 may also be applied to user messages before or after the message has been sent instead of upon receipt. In such case, the message would be filtered to determine, for example, whether the message should be stored in a particular folder once sent.

### Example Machine and Software Architecture

Embodiments used to facilitate and perform the electronic operations described herein may be implemented in one or a combination of hardware, firmware, and software. The functional units or capabilities described in this specification may have been referred to or labeled as components, processing functions, or modules, in order to more particularly emphasize their implementation independence. Such components may be embodied by any number of software or hardware forms. For example, a component or module such as that illustrated in FIG. 4 may be implemented as a hardware circuit comprising custom circuitry or off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. The executables of an identified component or module need not be physically located together, but may comprise disparate instructions stored in different locations which, when joined logically together, comprise the component or module and achieve the stated purpose for the component or module.

A component or module of executable code may be a single instruction, or many instructions, and may even be distributed over several different code segments, among different programs, and across several memory devices or processing systems. In particular, some aspects of the described process may take place on a different processing system (e.g., in a computer in a cloud-hosted data center) than that in which the code is deployed (e.g., in a test computing environment). Similarly, operational data may be included within respective components or modules, and may be embodied in any suitable form and organized within any suitable type of data structure. The operational data may be collected as a single data set, or may be distributed over different locations including over different storage devices.

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that a record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

The components, methods, applications, and so forth described in conjunction with FIGS. 2-4 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes such as those described herein. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the disclosed subject matter in different contexts from the disclosure contained herein.

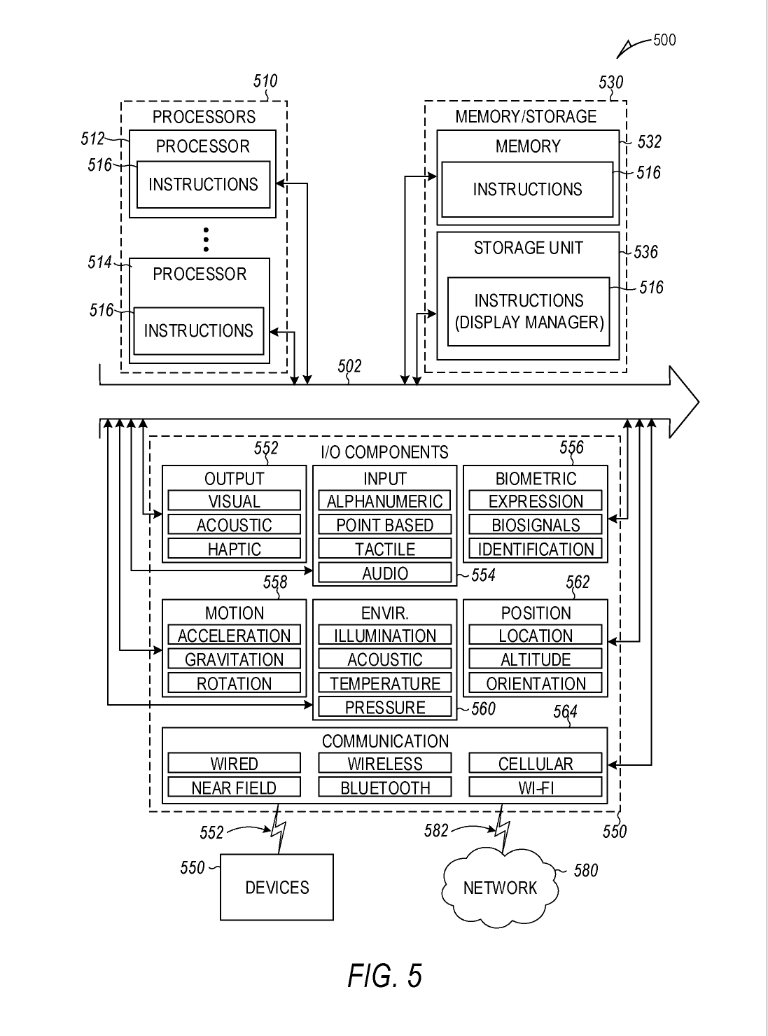

FIG. 5 is a block diagram illustrating components of a machine 500 that according to some example embodiments is able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. The instructions 516 transform the general, non-programmed machine into a particular machine programmed to carry out the described and illustrated functions in the manner described. For example, the instructions 516 may implement an email server such as OUTLOOK MAIL® that implements the rules with user adaptable controls features described herein. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In a sample embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various sample embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further sample embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure bio-signals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components, or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

In various sample embodiments, one or more portions of the network 580 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 7G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Those skilled in the art will appreciate that the rules with user adaptable controls system described herein may be used for email systems applications provided by Microsoft Corporation as well as by other providers. Moreover, those skilled in the art will appreciate that the mailbox management action specified by the rule with user adaptable controls may be a default action and the notification presented to the user may give the user the option to cancel the default action. In this embodiment, the rule with user adaptable controls would pop up an alert saying “This email meets the following rule. The following action will be taken in 5 seconds.” The user could be given an option or simply a “cancel” button to stop the default action. These and other embodiments are included within the scope of the following examples.

### NUMBERED EXAMPLES

Certain embodiments are described herein as numbered examples 1, 2, 3, etc. These numbered examples are provided as examples only and do not limit the subject technology.

Example 1 is a method of filtering electronic messages comprising: receiving at least one criterion for filtering electronic messages, at least one mailbox management action to be executed upon satisfaction of the at least one criterion, and a notification to be presented prior to execution of the at least one mailbox management action upon satisfaction of the at least one criterion; receiving an electronic message; determining that the electronic message satisfies the at least one criterion; in response to determining that the electronic message satisfies the at least one criterion, issuing a notification corresponding to a satisfied criterion, the notification including at least one graphical user interface (GUI) input element prompting a user to provide an input via the at least one GUI input element to select a mailbox management action from at least one mailbox management action presented in the notification; receiving a user input via the at least one GUI input element selecting a mailbox management action from the at least one mailbox management action presented in the notification; and responsive to the user input, executing the selected mailbox management action on the electronic message.

Example 2 is a method as in Example 1 wherein the notification includes text providing context for the mailbox management action to be taken upon satisfaction of the at least one criterion.

Example 3 is a method as in Example 1 further comprising enabling the user to select whether a received electronic message is to be evaluated against the at least one criterion upon receipt or when the electronic message is opened by the user for viewing.

Example 4 is a method as in Example 1 wherein issuing the notification comprises issuing one of a popup window alert and a toolbar graphical control element that appears as a temporary extension of a toolbar, the popup window alert and the graphical control element containing alert text setting forth the at least one mailbox management action.

Example 5 is a method as in Example 4 wherein issuing the notification comprises issuing one of the popup window alert and the toolbar graphical control element alert each time the electronic message is viewed by the user.

Example 6 is a method as in Example 4 wherein issuing the notification comprises issuing one of the popup window alert and the toolbar graphical control element alert a first time the electronic message is viewed by the user and then dismissing the alert.

Example 7 is a method as in Example 1 wherein the at least one mailbox management action includes at least one of forwarding the electronic message to a particular person, tagging the electronic message with a particular category, storing the electronic message in a particular folder, and flagging the electronic message for follow-up at a certain point in time.

Example 8 is a method as in Example 1 wherein the at least one mailbox management action comprises at least two mailbox management action possibilities for user selection upon satisfaction of the at least one criterion and the notification prompts the user to select one of the at least two mailbox management action possibilities for execution.

Example 9 is a machine readable medium that stores instructions thereon that when executed by one or more processing devices cause the one or more processing devices to implement a method of filtering electronic messages, comprising: setup instructions to generate a graphical user interface through which a user provides input to set at least one criterion for filtering electronic messages, at least one mailbox management action to be executed upon satisfaction of the at least one criterion, and a notification to be presented prior to execution of the at least one mailbox management action upon satisfaction of the at least one criterion; instructions to receive an electronic message; instructions to evaluate the electronic message against the at least one criterion to determine that the electronic message satisfies the at least one criterion; instructions to issue a notification corresponding to a satisfied criterion, the notification including at least one graphical user interface (GUI) input element prompting a user to provide an input via the at least one GUI input element to select a mailbox management action from at least one mailbox management action presented in the notification when the electronic message satisfies the at least one criterion, the at least one mailbox management action presented in the notification for selection corresponding to the at least one mailbox management action, specified by the user during execution of the setup instructions, that is to be executed when the electronic message satisfies the at least one criterion; instructions to receive a user input via the at least one GUI input element selecting a mailbox management action from the at least one mailbox management action presented in the notification; and instructions to execute the selected mailbox management action on the electronic message.

Example 10 is a medium as in Example 9 wherein the setup instructions include instructions to generate a GUI with an option to select at least one of an automatic rule and a user adaptable rule to be implemented upon satisfaction of the at least one criterion.

Example 11 is a medium as in Example 9 wherein the setup instructions include instructions to generate a GUI with an option to select at least one of automatically generated text and custom text created by the user for presentation upon satisfaction of the at least one criterion for a user adaptable rule.

Example 12 is a medium as in Example 9 wherein the instructions to issue the notification include instructions to issue one of a popup window alert and a toolbar graphical control element alert that appears as a temporary extension of a toolbar, the popup window alert and the graphical control element alert containing alert text setting forth the at least one mailbox management action.

Example 13 is a medium as in Example 12 wherein the instructions to issue the notification comprise instructions to issue one of the popup window alert and the toolbar graphical control element alert each time the electronic message is viewed by the user.

Example 14 is a medium as in Example 12 wherein the instructions to issue the notification comprise instructions to issue one of the popup window alert and the toolbar graphical control element alert a first time the electronic message is viewed by the user and then to dismiss the alert.

Example 15 is a medium as in Example 9 wherein the at least one mailbox management action includes at least one of forwarding the electronic message to a particular person, tagging the electronic message with a particular category, storing the electronic message in a particular folder, and flagging the electronic message for follow-up at a certain point in time.

Example 16 is a medium as in Example 9 wherein the at least one mailbox management action comprises at least two mailbox management action possibilities for user selection upon satisfaction of the at least one criterion and the notification prompts the user to select one of the at least two mailbox management action possibilities for execution.

Example 17 is an email system that filters electronic messages, comprising: a processor, a mailbox, and a memory that stores instructions thereon that when executed by the processor cause the processor to implement a method of filtering electronic messages, comprising: instructions to set at least one criterion for filtering electronic messages, at least one mailbox management action to be executed upon satisfaction of the at least one criterion, and a notification to be presented prior to execution of the at least one mailbox management action upon satisfaction of the at least one criterion; instructions to receive an electronic message; instructions to evaluate the electronic message against the at least one criterion to determine that the electronic message satisfies the at least one criterion; instructions to issue a notification corresponding to a satisfied criterion, the notification including at least one graphical user interface (GUI) input element prompting a user to provide an input via the at least one GUI input element to select a mailbox management action from at least one mailbox management action presented in the notification when the electronic message satisfies the at least one criterion; instructions to receive a user input via the at least one GUI input element selecting a mailbox management action from the at least one mailbox management action presented in the notification; and instructions to execute the selected mailbox management action on the electronic message.

Example 18 is a system as in Example 17 wherein the memory further comprises instructions to enable the user to select whether a received electronic message is to be evaluated against the at least one criterion upon receipt or when the electronic message is opened by the user for viewing.

Example 19 is a system as in Example 17 wherein the at least one mailbox management action includes at least one of forwarding the electronic message to a particular person, tagging the electronic message with a particular category, storing the electronic message in a particular folder, and flagging the electronic message for follow-up at a certain point in time.

Example 20 is a system as in Example 17 wherein the at least one mailbox management action comprises at least two mailbox management action possibilities for user selection upon satisfaction of the at least one criterion and the notification prompts the user to select one of the at least two mailbox management action possibilities for execution.

In the above Detailed Description, various features may be grouped together to streamline the disclosure. However, the claims may not set forth every feature disclosed herein as embodiments may feature a subset of the features. Further, embodiments may include fewer features than those disclosed in a particular example. Also, although the subject matter has been described in language specific to structural features and/or methodological acts with respect to a particular email application provided by Microsoft Corporation, it is to be understood that the subject matter defined in the appended claims is not necessarily limited to the specific embodiments, features, or acts described above. Rather, the specific embodiments, features, and acts described above are disclosed as example forms of implementing the claims. Thus, the following claims are hereby incorporated into the Detailed Description, with a claim standing on its own as a separate embodiment.

What is claimed is:

1. A method of filtering electronic messages, comprising:
receiving at least one criterion for filtering electronic messages, at least one mailbox management action to be executed upon satisfaction of the at least one criterion, and a notification to be presented prior to execution of the at least one mailbox management action upon satisfaction of the at least one criterion;
receiving an electronic message;
determining that the electronic message satisfies the at least one criterion;
in response to determining that the electronic message satisfies the at least one criterion, issuing a notification corresponding to a satisfied criterion, the notification including at least one graphical user interface (GUI) input element prompting a user to provide an input via the at least one GUI input element to select a mailbox management action from at least one mailbox management action presented in the notification;
receiving a user input via the at least one GUI input element selecting a mailbox management action from the at least one mailbox management action presented in the notification; and
responsive to the user input, executing the selected mailbox management action on the electronic message.

2. A method as in claim 1, wherein the notification includes text providing context for the mailbox management action to be taken upon satisfaction of the at least one criterion.

3. A method as in claim 1, further comprising enabling the user to select whether a received electronic message is to be evaluated against the at least one criterion upon receipt or when the electronic message is opened by the user for viewing.

4. A method as in claim 1, wherein issuing the notification comprises issuing one of a popup window alert and a toolbar graphical control element that appears as a temporary extension of a toolbar, the popup window alert and the graphical control element containing alert text setting forth the at least one mailbox management action.

5. A method as in claim 4, wherein issuing the notification comprises issuing one of the popup window alert and the toolbar graphical control element alert each time the electronic message is viewed by the user.

6. A method as in claim 4, wherein issuing the notification comprises issuing one of the popup window alert and the toolbar graphical control element alert a first time the electronic message is viewed by the user and then dismissing the alert.

7. A method as in claim 1, wherein the at least one mailbox management action includes at least one of forwarding the electronic message to a particular person, tagging the electronic message with a particular category, storing the electronic message in a particular folder, and flagging the electronic message for follow-up at a certain point in time.

8. A method as in claim 1, wherein the at least one mailbox management action comprises at least two mailbox management action possibilities for user selection upon satisfaction of the at least one criterion and the notification prompts the user to select one of the at least two mailbox management action possibilities for execution.

9. A machine readable medium that stores instructions thereon that when executed by one or more processing devices cause the one or more processing devices to implement a method of filtering electronic messages, comprising:
setup instructions to generate a graphical user interface through which a user provides input to set at least one criterion for filtering electronic messages, at least one mailbox management action to be executed upon satisfaction of the at least one criterion, and a notification to be presented prior to execution of the at least one mailbox management action upon satisfaction of the at least one criterion;
instructions to receive an electronic message;
instructions to evaluate the electronic message against the at least one criterion to determine that the electronic message satisfies the at least one criterion;
instructions to issue a notification corresponding to a satisfied criterion, the notification including at least one graphical user interface (GUI) input element prompting a user to provide an input via the at least one GUI input element to select a mailbox management action from at least one mailbox management action presented in the notification when the electronic message satisfies the at least one criterion, the at least one mailbox management action presented in the notification for selection corresponding to the at least one mailbox management action, specified by the user during execution of the setup instructions, that is to be executed when the electronic message satisfies the at least one criterion;
instructions to receive a user input via the at least one GUI input element selecting a mailbox management action from the at least one mailbox management action presented in the notification; and
instructions to execute the selected mailbox management action on the electronic message.

10. A medium as in claim 9, wherein the setup instructions include instructions to generate a GUI with an option to select at least one of an automatic rule and a user adaptable rule to be implemented upon satisfaction of the at least one criterion.

11. A medium as in claim 9, wherein the setup instructions include instructions to generate a GUI with an option to select at least one of automatically generated text and custom text created by the user for presentation upon satisfaction of the at least one criterion for a user adaptable rule.

12. A medium as in claim 9, wherein the instructions to issue the notification include instructions to issue one of a popup window alert and a toolbar graphical control element alert that appears as a temporary extension of a toolbar, the popup window alert and the graphical control element alert containing alert text setting forth the at least one mailbox management action.

13. A medium as in claim 12, wherein the instructions to issue the notification comprise instructions to issue one of the popup window alert and the toolbar graphical control element alert each time the electronic message is viewed by the user.

14. A medium as in claim 12, wherein the instructions to issue the notification comprise instructions to issue one of the popup window alert and the toolbar graphical control element alert a first time the electronic message is viewed by the user and then to dismiss the alert.

15. A medium as in claim 9, wherein the at least one mailbox management action includes at least one of forwarding the electronic message to a particular person, tagging the electronic message with a particular category, storing the electronic message in a particular folder, and flagging the electronic message for follow-up at a certain point in time.

16. A medium as in claim 9, wherein the at least one mailbox management action comprises at least two mailbox management action possibilities for user selection upon satisfaction of the at least one criterion and the notification prompts the user to select one of the at least two mailbox management action possibilities for execution.

17. An email system that filters electronic messages, comprising:
a processor;
a mailbox; and
a memory that stores instructions thereon that when executed by the processor cause the processor to implement a method of filtering electronic messages, comprising:
instructions to set at least one criterion for filtering electronic messages, at least one mailbox management action to be executed upon satisfaction of the at least one criterion, and a notification to be presented prior to execution of the at least one mailbox management action upon satisfaction of the at least one criterion;
instructions to receive an electronic message;
instructions to evaluate the electronic message against the at least one criterion to determine that the electronic message satisfies the at least one criterion;
instructions to issue a notification corresponding to a satisfied criterion, the notification including at least one graphical user interface (GUI) input element prompting a user to provide an input via the at least one GUI input element to select a mailbox management action from at least one mailbox management action presented in the notification when the electronic message satisfies the at least one criterion;
instructions to receive a user input via the at least one GUI input element selecting a mailbox management action from the at least one mailbox management action presented in the notification; and
instructions to execute the selected mailbox management action on the electronic message.

18. A system as in claim 17, wherein the memory further comprises instructions to enable the user to select whether a received electronic message is to be evaluated against the at least one criterion upon receipt or when the electronic message is opened by the user for viewing.

19. A system as in claim 17, wherein the at least one mailbox management action includes at least one of forwarding the electronic message to a particular person, tagging the electronic message with a particular category, storing the electronic message in a particular folder, and flagging the electronic message for follow-up at a certain point in time.

20. A medium as in claim 17, wherein the at least one mailbox management action comprises at least two mailbox management action possibilities for user selection upon satisfaction of the at least one criterion and the notification prompts the user to select one of the at least two mailbox management action possibilities for execution.
